(19) United States
(12) Patent Application Publication
(10) Pub. No.: US 2013/0216705 A1
(43) Pub. Date: Aug. 22, 2013

(54) MULTIPURPOSE PIPETTING DEVICE AND METHODS OF USING SUCH A DEVICE

(71) Applicant: JULIAN SPRUNG, Miami Beach, FL (US)

(72) Inventor: JULIAN SPRUNG, Miami Beach, FL (US)

(21) Appl. No.: 13/398,036

(22) Filed: Feb. 16, 2012

(51) Int. Cl. B05D 5/10; A01G 29/00; G01F 11/00; A01K 61/00

(52) U.S. Cl. 427/207.1; 119/200; 47/57.5; 222/309; 222/310

(57) ABSTRACT

A multipurpose pipetting device may include a pump, a flexible hose, at least one substantially rigid tube, a removable pipette tip, and a valve element. The hose has a first end coupled to the pump and a second end coupled to a first end of the at least one substantially rigid tube. The pipette tip is removably coupled to the second end of the at least one substantially rigid tube. The valve element may be disposed proximate the second end of the at least one substantially rigid tube and arranged to prevent liquid backflow from the pipette tip into the substantially rigid pipe. Methods of using the device include feeding or applying a solution to an aquatic plant or animal, to a non-aquatic plant or animal, removing materials and substances from an aquarium bed, and/or applying an adhesive to affix an item, plant, or sessile invertebrate to a surface.

### CROSS REFERENCE TO RELATED APPLICATIONS

None.

### BACKGROUND

1. Field of Invention

The invention relates generally to pipetting devices for the controlled transfer of liquids, or solids suspended within liquids, and more particularly, to a multipurpose pipetting device and methods of using such a device to accomplish numerous tasks.

2. Related Art

Aquarists have long taken steps and utilized various tools and techniques to ensure the overall health of their aquariums and the aquatic life existing therein. For example, many types of aquatic animals such as, for example, corals and anemones, require special care including targeted feeding. To accomplish such targeted feeding aquarists often use a coral feeder, which typically includes a turkey baster-type device having a bulb and an elongated tube. Notwithstanding the length of the tube, the aquarist often still ends up inserting his/her hand into the aquarium to accomplish the task, particularly in the case of tall aquariums. Moreover, the use of a bulb to eject liquids from or suck liquids into the tube can be very imprecise. What is needed is a device that helps an aquarist avoid the foregoing disadvantages when caring for his/her aquarium and aquatic life.

### SUMMARY

In accordance with an embodiment of the invention, a multipurpose pipetting device may include a pump, a flexible hose coupled to the pump, at least one substantially rigid tube coupled to the flexible hose, a pipette tip coupled to the at least one substantially rigid tube, and a valve element. The flexible hose has a first end and a second end, the first end being coupled to the pump and the second end being coupled to a first end of the at least one substantially rigid tube. The pipette tip may be removably coupled to a second end of the at least one substantially rigid tube. The valve element may be provided proximate the second end of the at least one substantially rigid tube and arranged to prevent liquid backflow from the pipette tip into the substantially rigid pipe.

In accordance with another embodiment of the invention, a method of using the multipurpose pipetting device may be provided. The method may include feeding or applying a solution to an aquatic plant or animal, removing or dislodging materials and substances from an aquarium bed, and/or applying an adhesive to affix an item (including, for example, live plants or sessile animals) to a surface.

Further features and advantages, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of some embodiments of the invention, as illustrated in the accompanying drawings. Unless otherwise indicated, the accompanying drawing figures are not to scale. Several embodiments of the invention will be described with respect to the following drawings, in which like reference numerals represent like features throughout the figures, and in which:

FIG. 1 is a perspective view of the multipurpose pipetting device according to an embodiment of the invention;

FIG. 2 is an exploded perspective view of the multipurpose pipetting device of FIG. 1;

FIG. 3 is a partial detail view of a valve element of the multipurpose pipetting device of FIG. 1;

FIG. 4 is a partial detail view of a connection between the flexible hose and substantially rigid tube of the multipurpose pipetting device of FIG. 1;

FIG. 5 is a perspective view of the multipurpose pipetting device according to another embodiment of the invention;

FIG. 6 is a perspective view of the multipurpose pipetting device of FIG. 5 including a plurality of substantially rigid tubes detachably coupled together to define an extended rigid tube.

### DETAILED DESCRIPTION

Some embodiments of the invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the invention. All references cited herein are incorporated by reference as if each had been individually incorporated.

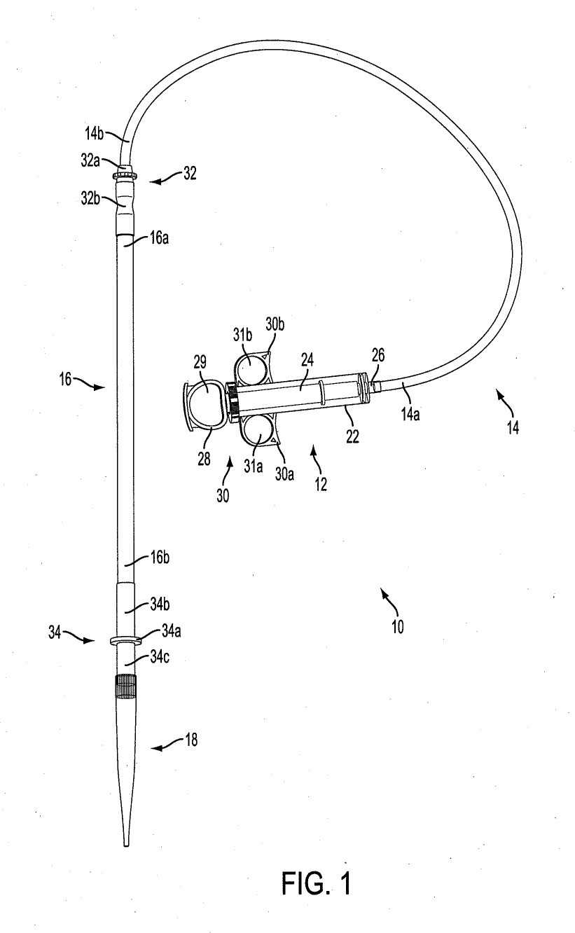

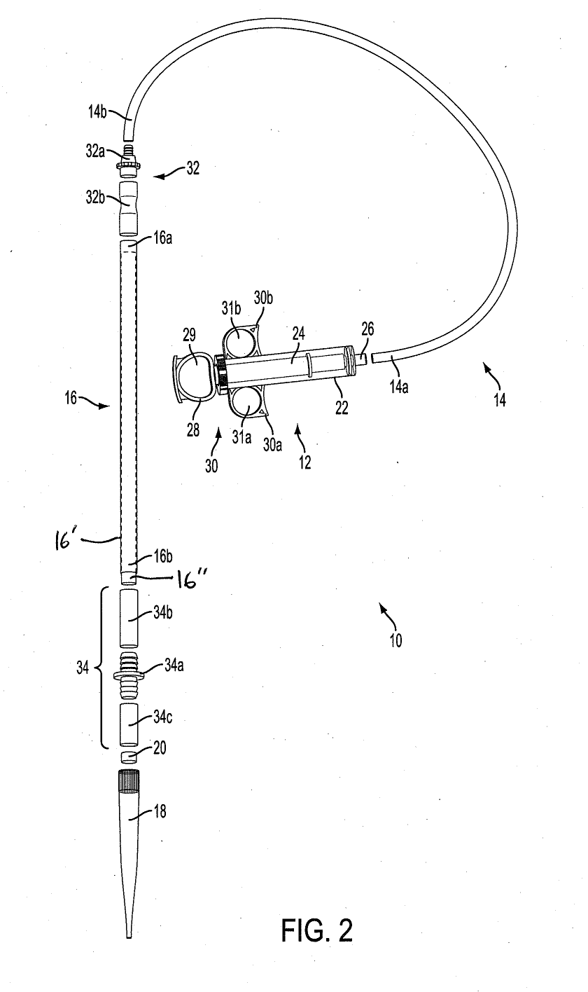

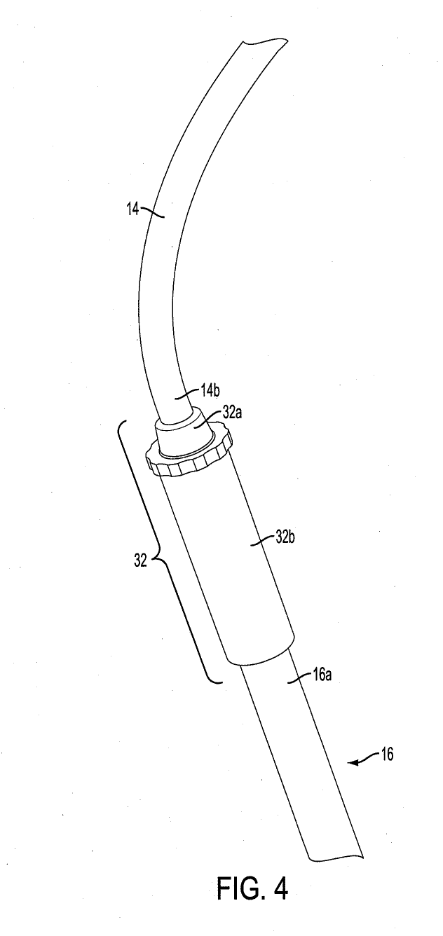

FIGS. 1 and 2 depict perspective views of a multipurpose pipetting device 10 in assembled and exploded form, respectively, according to an embodiment of the invention. As shown in the embodiment depicted in FIGS. 1 and 2, the device 10 includes, for example, a pump 12, a flexible hose 14 coupled to the pump 12, at least one substantially rigid tube 16 coupled to the flexible hose 14, a pipette tip 18 coupled to the at least one substantially rigid tube, and a valve element 20 (see FIGS. 2 and 4). The flexible hose 14 may have a first end 14a coupled to the pump 12 and a second end 14b coupled to a first end 16a of the substantially rigid tube 16. The pipette tip 18 may be removably coupled to a second end 16b of the rigid tube 16 and the valve element 20 may be provided proximate the second end 16b of the rigid tube 16 to prevent liquid backflow from the pipette tip 18 into the tube 16.

In the embodiment depicted in FIGS. 1 and 2, the pump 12 is in the form of a syringe having a tubular outer housing 22 and a plunger (piston) 24 movably disposed within the housing 22 to drawn in or dispense air through an orifice (opening) 26 at an open end of the housing 22. While the pump 12 is shown in FIGS. 1 and 2 as a syringe, the pump 12, alternatively, could be any other type of simple pump device such as, for example, a squeezable ball device (not shown) configured to create suction and dispense air when manually manipulated. This may, however, reduce the ability of the pump 12 to precisely disperse from or draw into the pipette tip 18 a desired or measured amount of a substance. That is, a syringe may give the user more precise control over both intake and ejection of the substance or solution. The syringe 12 may include a first finger-engagement portion 28 provided on an end of the plunger 24 opposite the orifice 26 and configured to be engaged by a finger (not shown) of a user to allow the user to move the plunger 24 within the tubular housing 22. As shown in FIGS. 1 and 2, the first finger-engagement portion 28 of the plunger 24 may be in the form of a loop or ring having a through hole 29 configured to receive the user's thumb. The syringe may include a second finger-engagement portion 30 extending radially outwardly from an outer surface of the housing 22 and configured to be engaged by at least one other finger of the user. The second finger-engagement portion 30 may be in the form of one or more loops or rings having a through hole 31 configured to receive the user's other finger(s). As shown in FIGS. 1 and 2, for example, the second finger-engagement portion 30 includes two loops 30a, 30b, having through holes 31a, 31b, respectively, and positioned opposite one another on the outer surface of the housing 22 for gripping by two fingers of the user. By utilizing the first and second finger-engagement portions 28, 30, a user may be able to bi-directionally manipulate the plunger 24 within the tubular housing 22 using only one hand or, as necessary, with two hands. By providing one-handed control of the syringe 12, the user has the continuous ability to draw in and purge the substance(s) as needed. This frees the other hand to position the tube 16 and tip 18 as needed.

The first end 14a of the flexible hose 14 is coupled to the orifice 26, either directly as shown or through one or more connectors (not shown). The second end 14b of the flexible hose 14 is coupled to the first end 16a of the substantially rigid tube 16, either directly or through one or more connectors 32. As shown in the embodiment depicted in FIGS. 1 and 2, for example, the connector 32 includes adapter 32a and tubular member 32b friction fit together to provide a sealed fluid connection between the flexible hose 14 and the rigid tube 16. Adhesive, threaded, snap-fit, or other connection mechanisms may also be used. FIG. 4 is a partial detail view of connector 32 coupling the second end 14b of the flexible hose 14 and first end 16a of the rigid tube 16. The substantially rigid tube 16 may be extendable and may include two or more pipes 16′, 16″, 16′″, etc. configured to telescope with respect to one another as shown in FIG. 2. That is, the tube 16 may be extended by utilizing two or more lengths of pipe 16′, 16″ slidably fit together (e.g., the OD of a first pipe being almost the same as the ID of a second pipe). The tube 16 may be formed of any suitable rigid material such as, for example, plastic (e.g., PVC, nylon, etc.) or metal (e.g., aluminum, stainless steel, or the like). An O-ring seal, sticky adhesive, rubber coating, or the like, (not shown) may be provided on exterior and/or interior surfaces of the pipes 16′, 16″ to allow telescoping while maintain a fluid seal and friction fit. The pipes 16′, 16″ may be linearly extended as needed and locked at a desired length by any known mechanism including, for example, friction, spring-loaded or biased detents, or another locking device such as, for example, a trifurcated collet and mandrel as taught in U.S. Pat. No. 4,238,164.

The pipette tip 18 is removably coupled to the second end 16b of the substantially rigid tube 16, either directly or through one or more connectors 34. As shown in the embodiment depicted in FIGS. 1 and 2, for example, the connector 34 may include a dual-ended male connector 34a and tubular members 34b,c friction fit together to provide a sealed fluid connection between the rigid tube 16 and the pipette tip 18. Adhesive, threaded, snap-fit, or other connection mechanisms may also be used. The pipette tip 18 may be disposable such that a user can remove, dispose of, and replace the pipette tip 18 as needed. According to an embodiment, the pipette tip 18 may be constructed of a plastic material and may be tapered or substantially conical along at least a portion of its length such that when a user cuts the pipette tip 18 transversely, an opening of a desired size is created. Alternatively or concurrently, a plurality of removable/replaceable tips 18 having different volumes and/or orifice sizes may be provided for different purposes (e.g., fine foods versus larger foods, viscous versus non viscous solutions). The tip 18 may also have other possible shapes such as, for example, a curved shape to allow the user to deposit glue or other solutions in a sideways fashion for applications that cannot be directly accessed with a straight tip. Alternatively or concurrently, the tube 16 could be curved or angled near the second end 16b or a curved or angled adaptor could be attached to accomplish the same purpose.

A volume of the pipette tip 18 relative to a volume of the pump 12 may limit the filling of the pipette tip 18 and prevent a liquid substance drawn into the tip 18 from going beyond the tip 18 into the tube 16. For example, in an embodiment in which the pump 12 is a syringe configured to be operated by one hand of the user, a natural distance for one-handed operation of the syringe on inflow (i.e., drawing the plunger 24 out of the housing 22) will just fill the pipette tip 18, even though the volume drawn into the syringe 12 could be further enlarged by using two hands. In a non-limiting example, the volume of the pump (syringe) 12 may be approximately 15 mL and the tip 18 may be a macro pipette tip having a volume of approximately 5 to 10 mL. The sizes of the syringe and tip could be modified as necessary to give the device the capacity to intake and hold more or less solution.

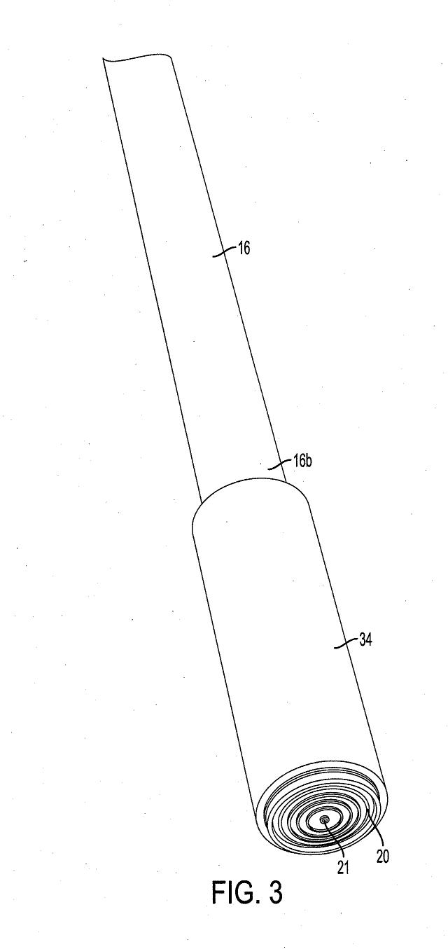

The valve element 20 may be provided between the pipette tip 18 and the second end 16b of the rigid tube 16 in order to prevent liquid backflow from the removable (disposable) pipette tip 18 into the substantially rigid pipe 16 during use. As shown in the embodiment depicted in FIGS. 2 and 3, the valve element 20 may be, for example, a cap-plug of substantially cylindrical or conical shape having a through hole 21 to allow air to flow therethrough when the pump 12 is activated. Although FIGS. 2 and 3 show the valve element 20 as a perforated cap-plug, one of ordinary skill in the art will recognize that any similar valve mechanism will be sufficient so long as it allows two-way air flow therethrough upon activation of the pump 12 to create suction in the pipette tip 18 to draw in a desired amount of a substance and dispense the same at a desired location. Without the valve element 20, liquid or other substances drawn into the pipette tip 18 could otherwise flow back toward the pump 12, potentially soiling or damaging the tubing 16, hose 14, and pump 12 (e.g., if the solution is a glue, a food, or a poison). The device 10 may be assembled by, for example, snug-fit, friction-fit, press-fit, snap-fit or thread-fit connections so it can be easily disassembled for cleaning. Alternatively, the device 10, other than the removable pipette tip 18, may be more permanently connected together by adhesive (glue), weld, or integral molding although this would make it more difficult to clean and/or replace damaged parts.

According to another embodiment, the device 10 could be utilized without the pipette tip and attached directly to another device for controllably adding or removing air, water, or another liquid or solution. For example, the device 10 could be used to dose a liquid or a gas into or remove a liquid or gas out of a bag or dome placed over a coral (not shown).

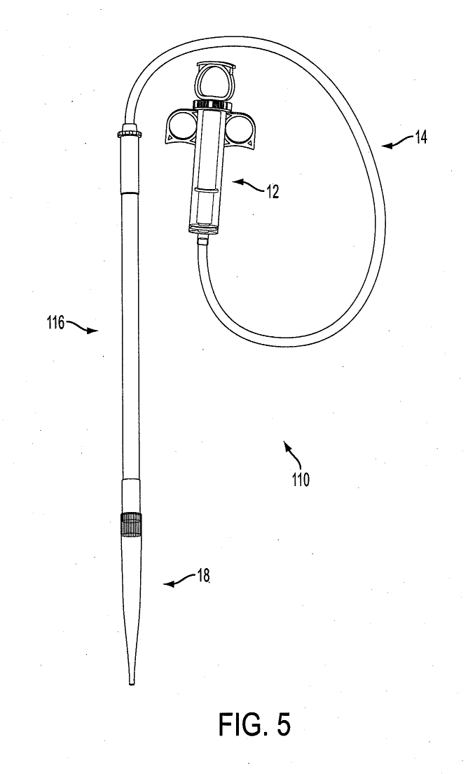

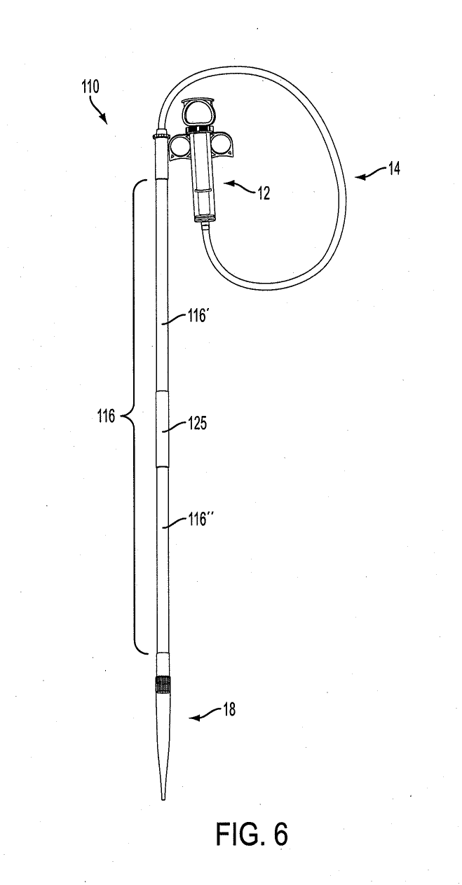

FIGS. 5 and 6 depict another embodiment of the device 110 having substantially all of the same components as the embodiment depicted in FIGS. 1-4 except including an alternative mode for extending the length of the substantially rigid tube 116. In this embodiment, rather than telescoping, multiple similarly sized pipes 116′, 116″ may be coupled together at their ends by a male/male, female/female, or male/female connector 125. For example, as shown, the connector 125 may be configured such that an inside diameter of the connector 125 matches an outside diameter of each of the pipes 116′, 116″ and thus provides a fluid/air sealed press- or friction-fit just by inserting. Connector 125 must form an air-tight seal to maintain pressure without leaks when the device is inserted deeply into an aquarium. In practice, this may be achieved by making connector 125 from a suitable material such as, for example but not limited to, soft PVC, silicone, rubber hose, or combinations thereof.

The device 10 or 110 may be utilized for a multitude of purposes, particularly in care for an aquarium and aquatic life contained therein without the need to put the user's hand in the aquarium due to the combined extendibility and flexibility of the device. In addition to use within an aquarium, the device may be utilized, for example, above water in a terrarium or anywhere that the long reach of the device simplifies the task of applying the food, solution, or adhesive or removing desired materials from a location. For example, the device may be utilized to precisely apply fine particulate food as a suspension over corals and sea anemones, zoanthids, or other filter-feeding and non-filter-feeding invertebrates. Additionally or alternatively, the device may be used, for example but not limited to, to “target feed” larger food pieces to the oral discs of corals, sea anemones, and zoanthids, or to feed timid invertebrates and fishes that don't compete well for food that is simply added to the aquarium such as, for example, seahorses, pipefish, dragonettes or newly acclimated fishes that are shy and unable to compete with established, more ravenous feeders. Additionally or alternatively, the device may also be used, for example, to apply poisonous or toxic liquids or substances directly over “pest” species in an aquarium (e.g., growing on rocks or other surfaces). Additionally or alternatively, the device may be used to, for example, to apply liquid cementing or affixing compounds or adhesives (glues) to secure corals or other invertebrates to rocks or other surfaces in a process called “spot welding.” In one example embodiment, the adhesive may include, for example, but not limited to, ethyl cyanoacrylate. Additionally or alternatively, the device may be utilized to siphon up algal films or other small objects in a very precise fashion. Additionally or alternatively, the device may be used to very precisely pump or squirt water jets into a substrate of the aquarium (e.g., sand, gravel or rock) to stir it up, clean it, and/or to dislodge settled detritus.

While various embodiments of the present invention have been described herein, it should be understood that they have been presented by way of example only, and not limitation. Thus, the breadth and scope of the present invention should not be limited by any of the described embodiments, but should instead be defined only in accordance with the following claims and their equivalents.

What is claimed is:

1. A multipurpose pipetting device comprising:
a pump;
a flexible hose having a first end and a second end, wherein the first end of the flexible hose is coupled to the pump;
at least one substantially rigid tube having a first end and a second end, wherein the first end of the at least one substantially rigid tube is coupled to the second end of the flexible hose;
a pipette tip removably coupled to the second end of the at least one substantially rigid tube; and
a valve element provided proximate the second end of the at least one substantially rigid tube and arranged to prevent liquid backflow from the pipette tip into the substantially rigid pipe.

2. The multipurpose pipetting device of claim 1, wherein the pump comprises a syringe including a plunger moveably disposed in a tubular housing, wherein the tubular housing having an orifice at an open end, and wherein the first end of the flexible hose is coupled to the orifice.

3. The multipurpose pipetting device of claim 2, wherein the plunger of the syringe includes a first finger-engagement portion configured to be engaged by a finger of a user to manipulate the plunger in at least one direction within the tubular housing.

4. The multipurpose pipetting device of claim 3, wherein the first finger-engagement portion of the plunger comprises a through hole configured to receive the user's thumb to allow bi-directional manipulation of the plunger within the tubular housing.

5. The multipurpose pipetting device of claim 4, wherein the tubular housing comprises a second finger-engagement portion extending radially outwardly from an outer surface of the housing and configured to be engaged by at least one other finger of the user.

6. The multipurpose pipetting device of claim 5, wherein the second finger-engagement portion comprises a through hole configured to receive the user's finger for gripping the tubular housing.

7. The multipurpose pipetting device of claim 1, wherein the at least one substantially rigid tube is extendable.

8. The multipurpose pipetting device of claim 7, wherein the at least one substantially rigid tube comprises a plurality of substantially rigid tubes telescopically coupled to one another.

9. The multipurpose pipetting device of claim 7, wherein the at least one substantially rigid tube comprises a plurality of substantially rigid tubes coupled together end to end by a connector.

10. The multipurpose pipetting device of claim 1, wherein the pipette tip is disposable.

11. The multipurpose pipetting device of claim 1, wherein the pipette tip is substantially conical and constructed of a plastic material, whereby when a user cuts the pipette tip transversely, an opening of a desired size is created.

12. The multipurpose pipetting device of claim 1, wherein the valve element comprises a cap-plug having a through hole.

13. The multipurpose pipetting device of claim 12, wherein air flows through the through hole when the pump is activated.

14. A method, comprising:
utilizing the multipurpose pipetting device of claim 1 to feed an aquatic animal.

15. The method of claim 14, wherein the aquatic animal is selected from the group consisting of fishes, corals, anemones, zoanthids, other anthozoans, filter-feeding invertebrates, and non-filter-feeding invertebrates.

16. A method, comprising:
utilizing the multipurpose pipetting device of claim 1 to apply a solution to an aquatic plant or an aquatic animal

17. The method of claim 16, wherein the aquatic animal is selected from the group consisting of corals, anemones, zoanthids, other anthozoans, filter-feeding invertebrates, and non-filter-feeding invertebrates.

18. The method of claim 16, wherein the aquatic plant is rooted in a substrate, and wherein the solution is a fertilizer that can be applied by the device onto leaves, stems or roots of the aquatic plant, or injected into the substrate to supply the fertilizing solution directly to the roots.

19. The method of claim 16, wherein the aquatic animal is Aiptasia spp. or Anemonia manjano and the solution is selected from the group consisting of lemon juice concentrate, calcium hydroxide, sodium hydroxide, hydrogen peroxide, any other toxic substance, and combinations thereof.

19. A method, comprising:
utilizing the multipurpose pipetting device of claim 1 to remove or dislodge materials and substances from an aquarium bed.

20. A method, comprising:
utilizing the multipurpose pipetting device of claim 1 to apply an adhesive to affix an item, plant, or sessile invertebrate to a surface.
